(19) United States
(12) Patent Application Publication
(10) Pub. No.: US 2004/0234567 A1
(43) Pub. Date: Nov. 25, 2004

(54) Collapsible shield for smoking animal lure

(76) Inventor: Richard A. Dawson, Belding, MI (US)

Correspondence Address: Waters & Morse, P.C., 400 Ledyard Building, 125 Ottawa, N.W., Grand Rapids, MI, 49503, US

(21) Appl. No.: 10/443,400

(22) Filed: May 22, 2003

(51) Int. Cl. A01N 25/00; A01M 1/10

(52) U.S. Cl. 424/405; 43/58

(57) ABSTRACT

A collapsible shield for a smoking animal lure product comprises a blank formed of sheet material that is folded flat for transportation and storage and erected at the site of use to form a tubular shield having a closed top that fits over an incense stick or other smoking animal attractant. The blank is formed of a plastic sheet material that is bendable along longitudinal score lines to form a tube. Top flaps are foldable downwardly to close an open top. Tab and slot fasteners hold the shield in its erected configuration. Lower and upper holes in the shield provide an inlet for combustion air and an outlet for smoke. The shield is held in place by nails or spikes that fit through holes in the lower edge of the shield.

### BACKGROUND OF THE INVENTION

One of the more effective devices for improving a hunter's odds against an animal is a smoke propagated animal attractant and cover scent of the type disclosed in Applicant's U.S. Pat. No. 5,618,548. As disclosed in this patent, a combustible material capable of smoldering and giving off smoke, such as an incense stick, is impregnated with an animal attractant or cover scent. The incense stick is then stuck in the ground and lit and the flame is blown out. The incense stick then continues to smolder and smoke, propagating the scent for long distances, where it is detected by the sensitive scent capabilities of animals.

When a smoking incense stick is used, the stick can be sensitive to environmental conditions, such as wind and rain. It is therefore desirable, under at least certain conditions, to be able to shield the stick from the environment. It is also desirable to be able to employ a shield around the stick when there is any danger that the smoking stick could cause a fire.

In applicant's U.S. Pat. No. 5,618,548, a number of different weather shield devices are disclosed. These include a lid mounted on a stick (in order to provide a rain shelter), a semi-cutaway coffee can, and a perforated plastic bucket. All of these are relatively inexpensive and effective. However, the bucket and coffee can devices, which serve as wind baffles as well as rain shields, are somewhat cumbersome to tote around in the woods. It is generally desirable to carry as few things as possible and to put as many things as possible into one's pockets, so that both hands can always maintain control of a weapon.

An object of the present invention is to provide an improved shield for a smoking animal lure product that is lightweight, compact, and collapsible so that it can be stored and conveyed in the hunter's pocket.

### SUMMARY OF THE INVENTION

In accordance with the present invention, a collapsible shield for a smoking animal lure product is formed from a foldable blank comprising a flat sheet material. The sheet material is bendable at least along score lines formed in the material. The sheet material is bendable into a tube by bringing side edges of the material together and attaching them together with suitable fasteners, preferably tabs and slots on the connecting edges. Upper and lower edges of the sheet material form upper and lower ends of the tube. The tube fits over an incense stick or the like and creates a desirable draft and shields the stick from wind and elements that could extinguish the combustion. The blank is formed with holes in upper and lower portions thereof so as to permit airflow through the shield sufficient to maintain controlled combustion of the smoking incense stick while providing an outlet for the smoke. Desirably, the blank has a series of tabs at upper ends thereof that fold over and lock together in order to form a top on the shield for protecting the incense stick from rain and controlling the rate of flow of air through the shield.

These and other objects and advantages of the present invention will hereinafter appear, and for purposes of illustration, but not of limitation, a preferred embodiment of the present invention is described in detail below and shown in the appended drawings.

### BRIEF DESCRIPTION OF THE DRAWINGS

FIG. 1 is a plan view of a blank of sheet material from which the shield of the present invention is fabricated.

FIG. 2 is an assembled view of the shield of the present invention.

FIG. 3 is a fragmentary view showing the tab and slot arrangements at the side edges of the shield.

FIG. 4 is a fragmentary view showing the tab connections at the top of the shield.

### DETAILED DESCRIPTION OF PREFERRED EMBODIMENT

Referring now to the drawings, a shield 10 for an incense stick 12 or other smoke producing product that serves as an animal lure or cover scent is shown in FIG. 2. For purposes of illustration, the smoking animal lure or cover scent will be referred to herein as an incense stick. It is understood that this term will refer to any type of smoking product that may be appropriately enclosed with a shield of the type disclosed herein.

Shield 10 comprises a tubular sidewall or body 14 having an upper end 16, and a lower end 18. Lower end 18 is designed to be placed on the ground over incense stick 12. Tubular body 14 has a generally polygonal configuration (hexagonal in the illustrated embodiment) when formed out of a relatively stiff material by bending the material on score lines. Alternatively, the body can be formed in a cylindrical shape by bending the material when a suitably thin material is used. Score lines are usually desirable to assist in the formation of the body, even when the material is thin enough to bend into a cylindrical shape. The score lines make folding and forming the material easier for packaging and assembly purposes.

Upper end 16 of the body is enclosed with a cover 19, described below. One or more lower air inlet holes 20 are formed in the body 14 of the shield at a generally lower position in the shield. A plurality of upper smoke outlet holes 24 are formed in an upper portion of the body around the outer periphery of the shield. The inlet and outlet holes are sized and positioned so that sufficient air can be drawn into the housing through the lower air inlet holes 20 to maintain a slow, smoking combustion of the incense stick, while providing sufficient inlet and outlet holes to maintain combustion of the incense stick. As shown, the smoke outlet holes are positioned around the entire outer periphery of the shield. This makes the shield operate in the same way no matter which way the shield is facing with regard to a prevailing wind, and it always provides outlet holes that are facing in a downwind direction.

An important feature of the present invention is that the shield is formed, preferably by die stamping, from a blank 30 of flat sheet material that can be carried flat, preferably folded up, carried in a pocket for easy transportation, and can be assembled and releasibly clipped together on site for use in the form shown in FIG. 2. Blank 30 is desirably formed of a flat sheet material that has limited combustion capabilities. A conventional plastic is generally satisfactory, especially since the combustion product is a smoldering incense stick and is not intended to produce a hot flame. One suitable plastic resin is utility grade, black, smooth, high density polyethylene sheeting. Other flexible plastic resins also are suitable for the present invention. Desirably, the material is sufficiently stiff so that the shield holds its shape when constructed but is sufficiently flexible that the shield does not break and can be folded into shape along score lines formed in the material. Score lines are desirable because they permit the shield to be easily folded into a predetermined shape for carrying in a pocket. The score lines are narrow spaced slits in or through the surface of the material. Score lines are not necessary if the material is not folded or if the material is thin enough that it can be folded without score lines. The desired wall thickness produces a relatively stiff material that is still flexible enough to fold into shape and fold into a compact package for carrying in a pocket.

Desirably, with a high density polyethylene material, the wall thickness is about thirty thousandths (0.030) inches plus or minus five thousandths (0.005) inches. A thickness range of fifteen (0.015) to one hundred twenty-five (0.125) thousandths is operable. A thinner wall could be too flimsy and a thicker wall is unnecessary, too thick to form in a typical stamping operation and too thick for convenient folding.

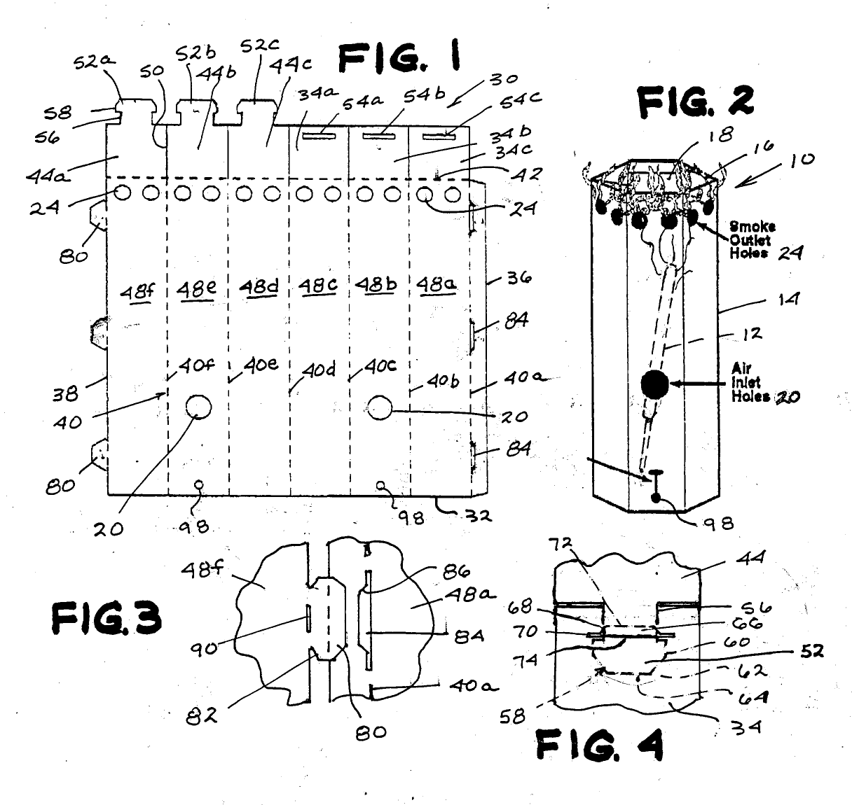

The construction of blank 30 is shown in FIG. 1. Blank 30 includes a bottom edge 32, a top edge 34, and side edges 36 and 38. Vertical or longitudinal score lines 40 are horizontally spaced along the surface of the blank and extend from the bottom to an upper end 16 of the shield body dividing the blank into vertical panels 48. Cover flaps 44 and 46 extend upwardly from the ends of the individual panels 48 forming the sides or body of the shield. Cover flaps 44 and 46 are separated by slots 50 so that the cover flaps may be manipulated separately.

In the exemplary embodiment, blank 30 is about 11¾ inches wide, which gives the tubular body a diameter of about 3.7 inches. The sidewalls are approximately 10 inches high, the flaps 46 are approximately 1⅝ inches high, and flaps 44 are approximately 2⅜ inches high, with the difference in height of the two flaps being the length of connecting tabs 52 on the top of flap 44.

Tabs 52 are labeled 52a, 52b, and 52c. These tabs fit into corresponding slots in flaps 46. These slots are labeled with numerals 54a, 54b, and 54c. Tab 52a fits in slot 54a, tab 52b fits in slot 54b, and tab 52c fits in slot 54c.

As shown in FIG. 4, tabs 52 have a neck 56 and a head 58. Head 58 has a side flange 60 extending outwardly from neck 56. The outer end of the head has an inwardly tapered portion 62 which terminates in end 64, giving the tab an arrowhead appearance. Slot 54 has a central open portion 66 having front edge 72, back edge 74, and tapered ends 68. End slots 70 extend outwardly from the outer ends of tapered ends 68. The head fits between outer ends of slots 70 to insert the tab in the slot, while the enlarged open portion 66 of the slot receives the neck 56 of the tab. This construction permits easy insertion of the tab in the slot but resists withdrawal of the tab from the slot, unless the tab is pulled and twisted with enough force to insure that the tab was intended to be disengaged.

The construction of the tabs and slots connecting the side edges of the shield is somewhat similar, except that the tabs 80 have a shorter neck 82 that tapers inwardly into contact with edge 38 of the side of the blank. Slot 84 has the same tapered end 86 as tapered end 68. Thin end slots 88 are similar to slots 70, except that slots 88 can constitute part of the score line 40a that is aligned with slots 84.

Desirably, tabs 80 have score grooves 90 at the base thereof so that the tabs can be bent easily to fit through slots 84. The edge 36 of the blank also can be bent easily along score line 40a so as to facilitate insertion and removal of tabs 80 therefrom.

The blank is also provided with air inlet holes 20 at a lower portion thereof. These inlet holes should be low enough that sufficient air can be drawn into the shield to provide oxygen for combustion of the incense stick. In the illustrated embodiment, holes 20 are 3/4 inch in diameter and are approximately 2⅜ inches from the bottom edge 32 of the blank. These openings can be spaced somewhat above the bottom of the blank because the flammable material in incense sticks does not extend all the way to the bottom end of the stick and because it is not desirable to enhance the combustion of the stick all the way to the ground. This reduces the risk of burning grass adjacent the bottom of the shield.

The smoke outlet holes 24 along the upper edge of the body of the shield are spaced around the entire periphery of the body. These holes can be somewhat smaller, because there are more of them and because it is desirable to position them all the way around the periphery of the body, so that the positioning of the shield is independent of the direction from which the wind is blowing. In the illustrated embodiment, openings 24 are approximately ½ inch in diameter, and there are twelve openings along the upper end of the shield, two in each panel 48.

The sizes of the inlet and outlet openings in the body is an important feature of the invention. The holes should be sized so that the tubular shield allows sufficient air to be drawn into the interior of the shield to support a slow, smoldering combustion of an incense stick, without restricting air flow so much that combustion is extinguished and without providing so much air that the incense stick burns too quickly. With the preferred ventilation hold construction, the area of the outlet hole is greater than the area of the inlet hole. This enhances a slow burn.

In the preferred embodiment, two lower holes 3/4 inches in diameter provide a total air inlet area of about 0.8 square inches. This, in combination with an air outlet hole area of about 2.3 square inches (twelve holes one-half inches in diameter) permits an incense stick to burn for as long as two to two and one-half hours. The use of three lower holes instead of two, providing an area of about 1.2 square inches is also satisfactory. However, when a fourth hole is used, increasing the area to about 1.6 square inches, the incense stick seems to burn too fast. A single lower hole providing an area of about 0.4 square inches does not appear to provide enough air for combustion. Thus an inlet hole area in the range of greater than 0.4 square inches and less than about 1.6 square inches appears to provide sufficient but not too much air for a slow burn in the embodiment described herein.

The outlet holes should be large enough that the release of exhaust gasses is impeded but not so much that the incense stick goes out. An outlet hole area of at least about twice the inlet hole area is generally satisfactory. The outlet hole area should be small enough that there is sufficient back pressure that air flow through the shield, which acts somewhat like a chimney, is slowed but not so much that the incense stick is extinguished. The areas of the inlet and outlet holes can vary with other factors, such as the diameter of the tubular shield body.

To carry the shield to and from a hunting site, the shield desirably is folded along two or more of the vertical score lines 40 so as to make a flat folded strip of material that can easily be fit into a pocket. Typically, the blank is folded by bending panels 48a and 48f inwardly along score lines 40b and 40f, and then folding the blanks in half along score line 40d. The folded shield can then be put in a pocket directly or inserted in a pouch or plastic bag.

To assemble the product for the first time, the plastic sheeting is first flexed a few times along the score lines to make the material more pliable. The body is then formed in tubular form by bringing the side edges 38 and 36 together. Tabs 80 are then inserted into slots 84, locking the shield into a hexagonal tubular form. The top is then formed on the shield by first folding flaps 44b and 34b into a horizontal position on fold line 42 and inserting tab 58b into slot 54b. Flaps 52a and 52c can then be folded over in any order, with tabs 58a and 58c being inserted respectively into slots 54a and 54c. This provides a secure, weather tight top to the shield that is easily disconnectable for disassembly and stowing of the shield.

At the lower end of the shield, two or more nail or stake openings 98 are formed on opposite sides of the shield. These openings are relatively small but large enough for insertion of hold down nails or stakes 100, which can be inserted through the openings and driven into the ground, as shown FIG. 2, in order to secure the shield in place on the ground. Any relatively long nail, stake, rod, or stick will do.

In using the shield of the present invention, the user should make sure that the incense stick on which the shield is employed is not burning with an active flame. The flame should be blown out so that the stick is merely smoldering when the shield is installed over the incense stick. A ten inch shield is designed to be used with an incense stick about ten inches long, including the handle, with the coating being about eight inches long. The upper end of the stick is therefore positioned below the top of the shield when the handle has been inserted into the ground.

While conventional plastic sheet materials are generally adequate for a shield used for a smoldering incense stick, if desired less flammable plastics can be used and flame retardant chemicals can be added to plastics in order to make the plastics even less flammable. This technology is well known and flame retardant plastic resins are readily available.

It should be understood that the foregoing is merely exemplary of the preferred practice of the present invention and that various changes in the arrangements and details of construction of the embodiments disclosed herein may be made without departing from the spirit and scope of the present invention.

I claim:

1. A collapsible shield for a smoking animal lure product comprising a flexible blank formed of a flat sheet material, the sheet material being bendable at least when score lines are formed in the material, the sheet material being bendable into a tube by bringing side edges of the material together, with upper and lower edges of the sheet material forming upper and lower ends of the tube; the shield further including releasable fasteners that hold the blank in its tubular configuration, the sheet material having openings therein that are sized to provide a level of airflow in the interior of the tube to sustain smoldering combustion of a smoking incense stick that is positioned inside the shield, with the bottom end of the tube positioned on the ground.

2. A collapsible shield as in claim 1 wherein the blank is formed of a material that includes a synthetic resin.

3. A collapsible shield as in claim 2 wherein the blank is formed of a synthetic resin and includes spaced longitudinal score lines that facilitate the sheet material being bent into tubular form.

4. A collapsible shield as in claim 1 wherein the fasteners comprise interengageable tabs and slots spaced along the side edges of the sheet material.

5. A collapsible shield as in claim 1 wherein the synthetic resin comprises high density polyethylene sheeting.

6. A collapsible shield as in claim 5 wherein the synthetic resin includes an additive that reduces the flammability of the resin.

7. A collapsible shield as in claim 1 wherein the sheet material is about 0.015 to about 0.125 inches thick.

8. A collapsible shield as in claim 1 wherein the shield, when assembled, is about three to four inches in diameter.

9. A collapsible shield as in claim 1 wherein the shield, when assembled, is about 3½ inches in diameter.

10. A collapsible shield as in claim 1 wherein the shield is at least about ten inches long when assembled.

11. A collapsible shield as in claim 1 wherein the blank has a plurality of end flaps extending upwardly along the upper edge thereof, the end tabs being bendable so as to substantially cover the upper end of the shield after it has been bent into its tubular form, flaps on one side of the upper end of the shield having tabs that engage slots on opposite sides of the shield so as to hold the tabs in a closing position over the top.

12. A collapsible shield as in claim 1 wherein the blank includes a plurality of spaced longitudinal score lines that leave a plurality of parallel, relatively narrow strips of the blank between the score lines, the shield being stowable by releasing the fasteners and folding the sides of the blank together along the score lines, producing a compact pack of flat narrow strips of sheet material for easy storage.

13. A collapsible shield as in claim 1 wherein the blank includes closeable end flaps that extend outwardly from spaced locations along the upper end of sidewalls formed in the sheet material, the flaps being foldable inwardly along a score line at upper end of the sidewall and having tab fasteners at the ends of opposing flaps that hold the flaps in a folded position.

14. A stowable shield as in claim 13 wherein the shield comprises a plurality of spaced openings around the periphery of the shield at an upper portion thereof and at least one opening at a lower portion thereof, such that sufficient air for smoldering combustion can flow into the shield and heat and exhaust gases can be discharged from the shield, the openings in the shield being sufficient to release smoke from the shield but being small enough in number and size that the openings do not prevent the shield from resisting the extinguishing of the incense stick by lateral winds bearing on the shield.

15. A collapsible shield as in claim 1 wherein the tube has a closed top and comprises lower inlet holes for combustion air and upper exhaust holes for exhaust gasses, the holes being sized so as to maintain a slow, smoldering combustion of a burning incense stick placed therein.

16. A collapsible shield as in claim 15 wherein the total area of the inlet holes is no more than the total area of the outlet holes.

17. A collapsible shield as in claim 15 wherein the total area of the inlet holes is less than about 1.6 square inches.

18. A collapsible shield as in claim 15 wherein the upper holes are sized to restrict the rate of exhaust gas outflow so as to cause an incense stick to burn slowly without extinguishing the incense stick.
